(19) United States
(12) Patent Application Publication
(10) Pub. No.: US 2019/0035530 A1
(43) Pub. Date: Jan. 31, 2019

(54) REACTOR HAVING CORE BODY INTERPOSED BETWEEN END PLATE AND PEDESTAL

(71) Applicant: FANUC CORPORATION, Yamanashi (JP)

(72) Inventors: Tomokazu YOSHIDA, Yamanashi (JP); Masatomo SHIROUZU, Yamanashi (JP); Kenichi TSUKADA, Yamanashi (JP)

(21) Appl. No.: 16/040,547

(22) Filed: Jul. 20, 2018

(30) Foreign Application Priority Data
Jul. 27, 2017 (JP) 2017-145691

(51) Int. Cl. H01F 27/26; H01F 27/29; H01F 3/14

(52) U.S. Cl. CPC H01F 27/26; H01F 3/14; H01F 27/29

(57) ABSTRACT

A reactor includes a core body having at least three iron cores, an end plate and a pedestal fastened to the core body so as to interpose the core body therebetween, and a plurality of shaft parts which support the core body between the end plate and the pedestal in the vicinity of an outer edge of the core body. Gaps, which can be magnetically coupled, are formed between the at least three iron cores. At least one of the plurality of shaft parts is used as a ground wiring terminal on an upper surface of the end plate.

### BACKGROUND OF THE INVENTION

### 1. Field of the Invention

The present invention relates to a reactor having a core body which is interposed between an end plate and a pedestal.

### 2. Description of Related Art

Reactors include a plurality of iron core coils, and each iron core coil includes an iron core and a coil wound onto the iron core. Predetermined gaps are formed between the plurality of iron cores. Refer to, for example, Japanese Unexamined Patent Publication (Kokai) No. 2000-77242 and Japanese Unexamined Patent Publication (Kokai) No. 2008-210998. Furthermore, there are also reactors in which a plurality of iron core coils are arranged inside an annular outer peripheral iron core. In such reactors, the core body is arranged between an end plate and a pedestal. In many cases, a ground wiring cable is connected to the pedestal of the reactor.

### SUMMARY OF THE INVENTION

Generally, reactors are impregnated with an impregnating agent after assembly. Thus, when a ground wiring cable is connected to the pedestal of the reactor, it is necessary to mask the portion of the pedestal to which the ground wiring cable is to be connected so as to prevent the impregnation of impregnating agent therein.

Alternatively, the ground wiring cable may be connected to the top of the reactor, for example, to a terminal block located above the end plate. In this case, since the connection location of the ground wiring cable is higher than the liquid surface of the impregnating agent, it is not necessary to perform a masking operation. However, it is necessary to additionally install a ground wiring terminal on the terminal block for the ground wiring cable, which is cumbersome.

Thus, a reactor to which a ground wiring cable can be easily connected is desired.

According to a first aspect of the present disclosure, there is provided a reactor comprising a core body including at least three iron cores, an end plate and a pedestal which are fastened to the core body so as to interpose the core body therebetween, and a plurality of shaft parts which support the core body between the end plate and the pedestal in a vicinity of an outer edge of the core body, wherein gaps, which can be magnetically coupled, are formed between one of the at least three iron cores and another iron core adjacent thereto, and at least one shaft part of the plurality of shaft parts is used as a ground wiring terminal on an upper surface of the end plate.

In the first aspect, since one of the plurality of shaft parts is used as a ground wiring terminal, it is not necessary to provide a dedicated ground wiring terminal. Furthermore, since the ground wiring terminal is located on the upper surface of the end plate, during impregnation, the ground wiring terminal is higher than the liquid surface of the impregnating agent, thereby eliminating the need to perform a masking operation. Thus, the ground wiring cable can be easily connected to the ground wiring terminal.

The object, features, and advantages of the present invention, as well as other objects, features and advantages, will be further clarified by the detailed description of the representative embodiments of the present invention shown in the accompanying drawings.

### BRIEF DESCRIPTION OF DRAWINGS

FIG. 1A is an exploded perspective view of a reactor according to a first embodiment.

FIG. 1B is a perspective view of the reactor shown in FIG. 1A.

FIG. 2 is a cross-sectional view of the core body of the reactor according to the first embodiment.

FIG. 3 is a partial perspective view of the reactor according to the first embodiment.

FIG. 4A is a perspective view of a reactor according to the prior art.

FIG. 4B is a partially enlarged view of the reactor shown in FIG. 4A.

FIG. 5 is a perspective view of another reactor according to the prior art.

FIG. 6 is a cross-sectional view of the core body of a reactor according to a second embodiment.

### DETAILED DESCRIPTION

The embodiments of the present invention will be described below with reference to the accompanying drawings. In the following drawings, the same components are given the same reference numerals. For ease of understanding, the scales of the drawings have been appropriately modified.

In the following description, a three-phase reactor will mainly be described as an example. However, the present disclosure is not limited in application to a three-phase reactor but can be broadly applied to any multiphase reactor requiring constant inductance in each phase. Further, the reactor according to the present disclosure is not limited to those provided on the primary side or secondary side of the inverters of industrial robots or machine tools but can be applied to various machines.

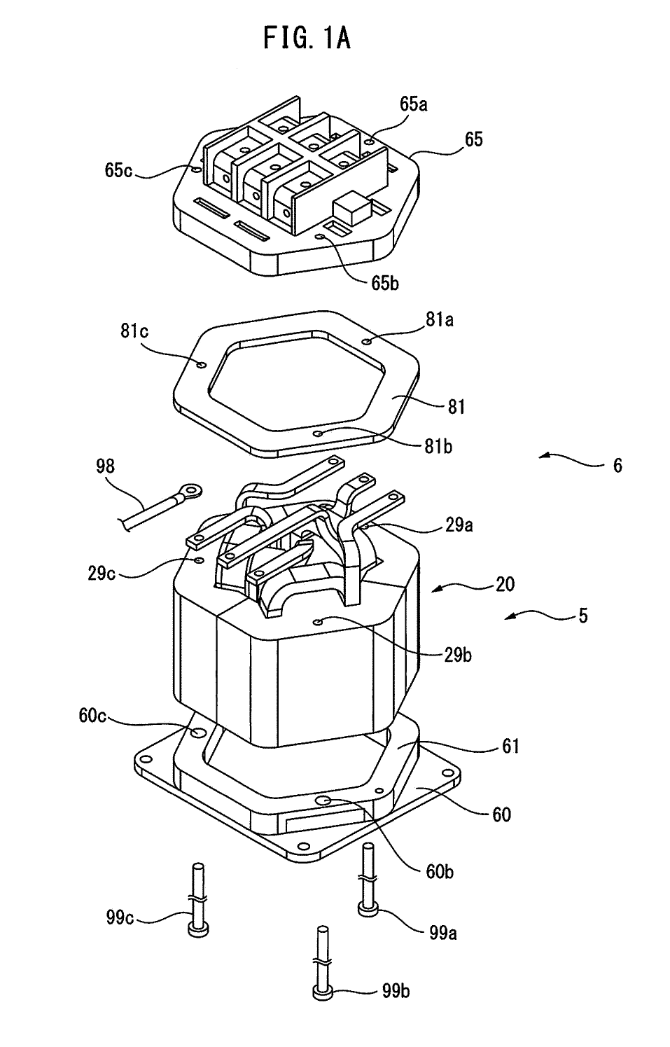

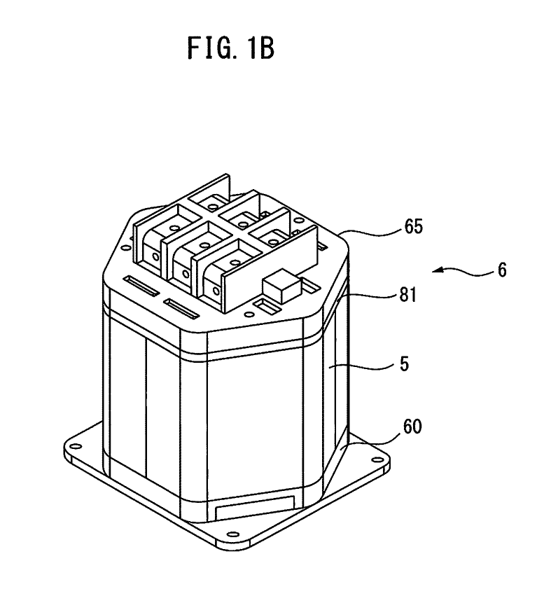

FIG. 1A is an exploded perspective view of a reactor according to a first embodiment and FIG. 1B is a perspective view of the reactor shown in FIG. 1A. As shown in FIG. 1A and FIG. 1B, the reactor 6 mainly includes a core body 5, a pedestal 60 attached to one end of the core body 5, and an annular end plate 81 attached to the other end of the core body 5. Further, the reactor 6 may include a terminal block 65 attached to the end plate 81. In such a case, the axial ends of the core body 5 are interposed by the pedestal 60 and the end plate 81 and terminal block 65.

An annular projecting part 61 having an outer shape corresponding to the end surface of the core body 5 is provided on the pedestal 60. Through-holes 60a to 60c, which penetrate the pedestal 60, are formed in the projecting part 61 at equal intervals in the circumferential direction. The end plate 81 has the same outer shape, and through-holes 81a to 81c are also formed in the end plate 81 at equal intervals in the circumferential direction. As will be described later, the heights of the projecting part 61 of the pedestal 60 and the end plate 81 are slightly greater than the protruding height of the coils 51 to 53 protruding from the end of the core body 5.

The terminal block 65 includes a plurality of, for example, six, terminals. The plurality of terminals are connected to a plurality of leads extending from the coils 51 to 53, respectively. Furthermore, through-holes 65a to 65c are formed in the terminal block 65 at equal intervals in the circumferential direction.

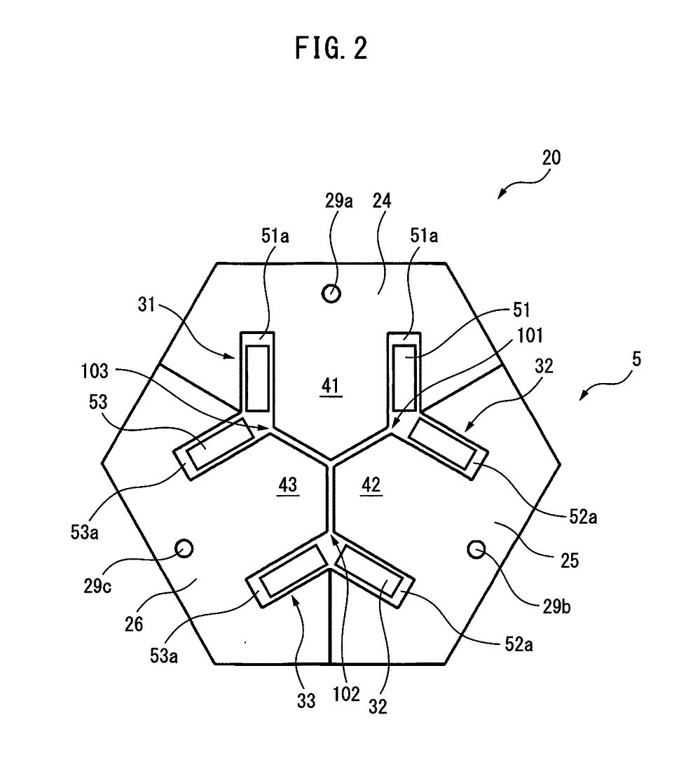

FIG. 2 is a cross-sectional view of the core body of the reactor according to the first embodiment. As shown in FIG. 2, the core body 5 of the reactor 6 includes an annular outer peripheral iron core 20 and three iron core coils 31 to 33, which are arranged inside the outer peripheral iron core 20. In FIG. 1A, the iron core coils 31 to 33 are arranged inside the substantially hexagonal outer peripheral iron core 20. The iron core coils 31 to 33 are arranged at equal intervals in the circumferential direction of the core body 5.

Note that the outer peripheral iron core 20 may have other rotationally symmetrical shapes, such as a round shape. In such a case, the shape of the outer peripheral iron core 20 corresponds to the shapes of the terminal block 65, the end plate 81, and the pedestal 60. Furthermore, the number of the iron core coils is a multiple of three, whereby the reactor 6 can be used as a three-phase reactor.

As can be understood from the drawings, the iron core coils 31 to 33 include iron cores 41 to 43, which extend in the radial directions of the outer peripheral iron core 20, and coils 51 to 53 wound onto the iron cores, respectively.

The outer peripheral iron core 20 is composed of a plurality of, for example, three, outer peripheral iron core portions 24 to 26 divided in the circumferential direction. The outer peripheral iron core portions 24 to 26 are formed integrally with the iron cores 41 to 43, respectively. The outer peripheral iron core portions 24 to 26 and the iron cores 41 to 43 are formed by stacking a plurality of magnetic plates, for example, iron plates, carbon steel plates, or electromagnetic steel plates, or are formed from a dust core. When the outer peripheral iron core 20 is composed of a plurality of outer peripheral iron core portions 24 to 26, even if the outer peripheral iron core 20 is large, such a large outer peripheral iron core 20 can be easily manufactured. Note that the number of the iron cores 41 to 43 and the number of the iron core portions 24 to 26 need not necessarily be the same. Furthermore, through-holes 29a to 29c are formed in the outer peripheral iron core portions 24 to 26, respectively.

The coils 51 to 53 are arranged in coil spaces 51a to 53a (“coil spaces 51a to 54a” in the second embodiment, which is described later) formed between the outer peripheral iron core portions 24 to 26 and the iron cores 41 to 43, respectively. In the coil spaces 51a to 53a, the inner peripheral surfaces and the outer peripheral surfaces of the coils 51 to 53 are adjacent to the inner walls of the coil spaces 51a to 53a.

Further, the radially inner ends of the iron cores 41 to 43 are each located near the center of the outer peripheral iron core 20. In the drawing, the radially inner ends of the iron cores 41 to 43 converge toward the center of the outer peripheral iron core 20, and the tip angles thereof are approximately 120 degrees. The radially inner ends of the iron cores 41 to 43 are separated from each other via gaps 101 to 103, which can be magnetically coupled.

In other words, the radially inner end of the iron core 41 is separated from the radially inner ends of the two adjacent iron cores 42 and 43 via gaps 101 and 103. The same is true for the other iron cores 42 and 43. Note that, the sizes of the gaps 101 to 103 are equal to each other.

In the configuration shown in FIG. 1A, since a central iron core disposed at the center of the core body 5 is not needed, the core body 5 can be constructed lightly and simply. Further, since the three iron core coils 31 to 33 are surrounded by the outer peripheral iron core 20, the magnetic fields generated by the coils 51 to 53 do not leak to the outside of the outer peripheral core 20. Furthermore, since the gaps 101 to 103 can be provided at any thickness at a low cost, the configuration shown in FIG. 1A is advantageous in terms of design, as compared to conventionally configured reactors.

Further, in the core body 5 of the present disclosure, the difference in the magnetic path lengths is reduced between the phases, as compared to conventionally configured reactors. Thus, in the present disclosure, the imbalance in inductance due to a difference in magnetic path length can be reduced.

As can be understood from FIG. 1A, a plurality of shaft parts, for example, long bolts 99a to 99c, pass through the through-holes 60a to 60c of the pedestal 60, the through-holes 29a to 29c of the core body 5, and the through-holes 81a to 81c of the end plate 81. The shaft parts 99a to 99c (“shaft parts 99a to 99d” in the second embodiment, which is described later) are preferably formed from a magnetic material.

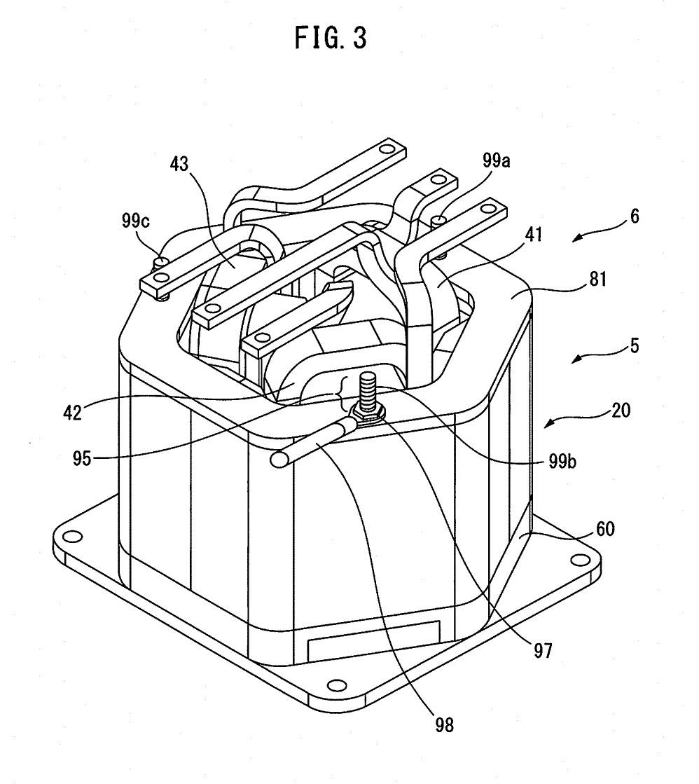

FIG. 3 is a partial perspective view of the reactor according to the first embodiment. As shown in FIG. 3, the tip portions of the plurality of shaft parts 99a to 99c protrude from the upper surface of the end plate 81. Further, on the upper surface of the end plate 81, one end of the ground wiring cable 98 is connected to one shaft part 99b of the plurality of shaft parts via a crimped terminal. A nut 97 is threadedly engaged with the threaded portion of the shaft part 99b, whereby one end of the ground wiring cable 98 is fixed to the upper surface of the end plate 81. The other end of the ground wiring cable 98 is grounded by a well-known grounding means.

Thus, in the first embodiment, one portion of the shaft part 99b, which is located above the end plate 81, is used as the ground wiring terminal 95. Nuts (not shown) are similarly threadedly engaged with the other shaft parts 99a, 99c, whereby the reactor 6 having the core body 5 disposed between the end plate 81 and the pedestal 60 without a terminal block 65 is formed. Note that ground wiring cables 98 may be connected to two or more of the plurality of shaft parts 99a to 99c.

Further, the pedestal 60, the core body 5, the end plate 81, and the terminal block 65 may be threadedly engaged with each other by passing the plurality of shaft parts 99a to 99c through the through-holes 65a to 65c of the terminal block 65. In this case, the core body 5 can be firmly fastened between the pedestal 60 and the end plate 81 and terminal block 65.

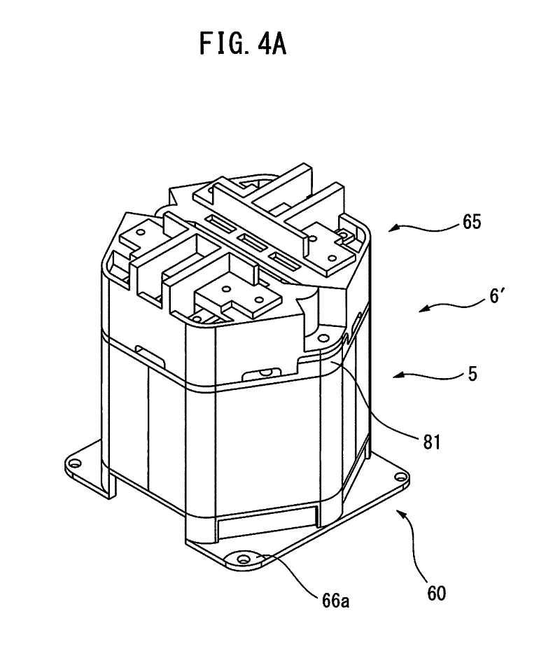

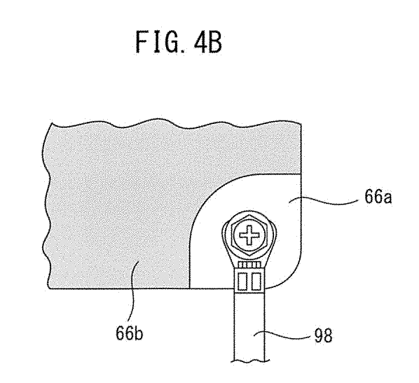

FIG. 4A is a perspective view of a reactor 6′ according to the prior art and FIG. 4B is a partially enlarged view of the reactor 6′ shown in FIG. 4A. As shown in these drawings, in the prior art, one end of the ground wiring cable 98 is screwed onto the opening of one corner part 66a of the pedestal 60 via a crimped terminal. To this end, it is necessary that one corner part 66a electrically conductive.

Generally, reactors are impregnated with an impregnating agent after assembly. Since the pedestal 60 is located on the lowermost portion of the reactor 6′, when the reactor 6′ is impregnated, naturally the impregnating agent will be applied to the pedestal 60 as well. However, when the one corner part 66a described above is impregnated, this corner part 66a will no longer be electrically conductive. Thus, in the prior art, the one corner part 66a is masked with respect to the remaining portions 66b so as not to be impregnated with the impregnating agent.

In contrast thereto, in the first embodiment, the ground wiring terminal 95 is located above the core body 5 and the end plate 81. When the reactor 6 is impregnated, by adjusting the amount of impregnating agent so that the ground wiring terminal 95 is located above the liquid level of the impregnating agent, it is possible to prevent the impregnation of the ground wiring terminal 95. In the first embodiment, since it is not necessary to connect the ground wiring cable 98 to the corner part 66a of the pedestal 60, the masking operation can be eliminated.

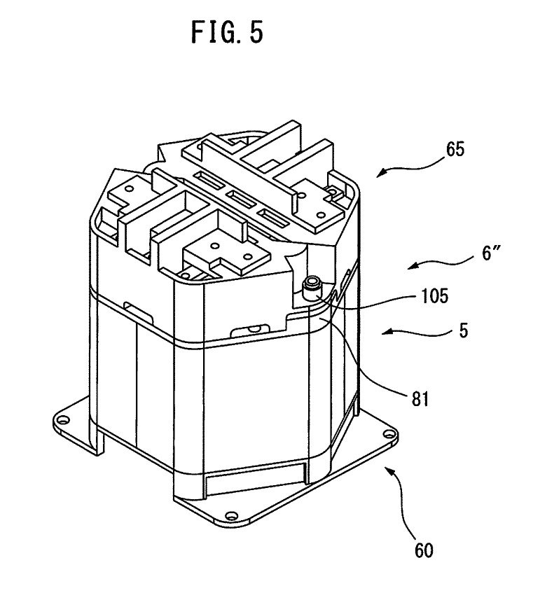

Further, FIG. 5 is a perspective view of another reactor 6″ according to the prior art. A ground wiring terminal 105 is additionally provided on the terminal block 65 of the reactor 6″ shown in FIG. 5. Since the ground wiring terminal 105 is arranged above the other reactor 6″, for the same reasons as described above, it is not necessary to perform a masking operation. However, it is necessary to install the ground connection terminal 105 of the other reactor 6″ on the terminal block 65, which is cumbersome.

In contrast thereto, in the first embodiment, one of one shaft part 99b of the plurality of shaft parts 99a to 99c is used as the ground wiring terminal 95. Thus, it is not necessary to additionally provide a dedicated ground wiring terminal 105, as in the prior art. Thus, the ground wiring cable 98 can be easily connected to the shaft part 99b as a ground wiring terminal 95.

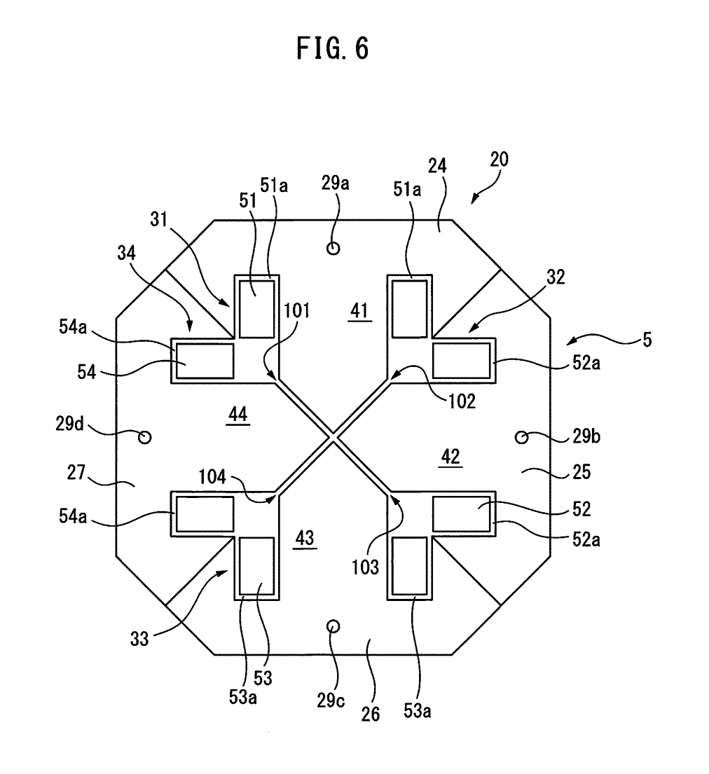

FIG. 6 is a cross-sectional view of the core body of a reactor according to a second embodiment. The core body 5 shown in FIG. 6 includes a substantially octagonal outer peripheral iron core 20 and four iron core coils 31 to 34, which are the same as the iron core coils described above, arranged inside the outer peripheral iron core 20. The iron core coils 31 to 34 are arranged at equal intervals in the circumferential direction of the core body 5. Furthermore, the number of the iron cores is preferably an even number not less than four, whereby the reactor including the core body 5 can be used as a single-phase reactor.

As can be understood from the drawing, the outer peripheral iron core 20 is composed of four outer peripheral iron core portions 24 to 27 divided in the circumferential direction. The iron core coils 31 to 34 include iron cores 41 to 44 extending in the radial directions and coils 51 to 54 wound onto the iron cores, respectively. The radially outer ends of the iron cores 41 to 44 are integrally formed with the outer peripheral iron core portions 24 to 27, respectively. Note that the number of the iron cores 41 to 44 and the number of the iron core portions 24 to 27 need not necessarily be the same. The same is true for the core body 5 shown in FIG. 2.

Further, each of the radially inner ends of the iron cores 41 to 44 is located near the center of the outer peripheral iron core 20. In FIG. 6, the radially inner ends of the iron cores 41 to 44 converge toward the center of the outer peripheral iron core 20, and the tip angles thereof are about 90 degrees. The radially inner ends of the iron cores 41 to 44 are separated from each other via the gaps 101 to 104, which can be magnetically coupled.

In the reactor 6 according to the second embodiment, the core body 5 is arranged between the pedestal 60 and end plate 81, which are shaped corresponding to the core body 5. The plurality of shaft parts 99a to 99d (not shown) are passed through the through-holes 60a to 60d of the pedestal 60, the through-holes 29a to 29d of the core body 5, and the through-holes 81a to 81d of the end plate 81. The ground wiring cable 98 is similarly connected to one portion of one shaft part 99b, which is located higher than the end plate 81, whereby the one portion of the shaft part 99b can be used as the ground wiring terminal 95. Thus, it can be understood that the same effects as described above can be obtained.

### ASPECTS OF THE DISCLOSURE

According to the first aspect, there is provided a reactor (6), comprising a core body (5) including at least three iron cores (41 to 44), an end plate (81) and a pedestal (60) which are fastened to the core body so as to interpose the core body therebetween, and a plurality of shaft parts (99a to 99c) which support the core body between the end plate and the pedestal in a vicinity of an outer edge of the core body, wherein gaps (101 to 104), which can be magnetically coupled, are formed between one of the at least three iron cores and another iron core adjacent thereto, and at least one shaft part of the plurality of shaft parts is used as a ground wiring terminal (95) on an upper surface of the end plate.

According to the second aspect, in the first aspect, the core body includes an outer peripheral iron core (20) composed of a plurality of outer peripheral iron core portions (24 to 27), the at least three iron cores are coupled to the plurality of outer peripheral iron core portions, and coils (51 to 54) are wound onto the at least three iron cores.

According to the third aspect, in the first or second aspect, the plurality of shaft parts are formed from a magnetic material.

According to the fourth aspect, in any of the first through third aspects, the number of the at least three iron cores is a multiple of three.

According to the fifth aspect, in any of the first through third aspects, the number of the at least three iron cores is an even number not less than 4.

### EFFECTS OF THE ASPECTS

In the first aspect, since one of the plurality of shaft parts is used as a ground wiring terminal, it is not necessary to provide a dedicated ground wiring terminal. Furthermore, since the ground wiring terminal is located on the upper surface of the end plate, during impregnation, the grounding terminal is higher than the liquid level of the impregnating agent, thereby eliminating the need to perform a masking operation. Thus, the ground wiring cable can be easily connected to the ground wiring terminal.

In the second aspect, since the coils are surrounded by the outer peripheral iron core, magnetic flux leakage can be prevented.

In the third aspect, the plurality of shaft parts are, for example, bolts.

In the fourth aspect, the reactor can be used as a three-phase reactor.

In the fifth aspect, the reactor can be used as a single-phase reactor.

Though the present invention has been described using representative embodiments, a person skilled in the art would understand that the foregoing modifications and various other modifications, omissions, and additions can be made without departing from the scope of the present invention.

1. A reactor, comprising a core body including at least three iron cores,
an end plate and a pedestal which are fastened to the core body so as to interpose the core body therebetween, and
a plurality of shaft parts which support the core body between the end plate and the pedestal in a vicinity of an outer edge of the core body, wherein
gaps, which can be magnetically coupled, are formed between one of the at least three iron cores and another iron core adjacent thereto, and
at least one shaft part of the plurality of shaft parts is used as a ground wiring terminal on an upper surface of the end plate.

2. The reactor according to claim 1, wherein the core body includes an outer peripheral iron core composed of a plurality of outer peripheral iron core portions,
the at least three iron cores are coupled to the plurality of outer peripheral iron core portions, and
coils are wound onto the at least three iron cores.

3. The reactor according to claim 1, wherein the plurality of shaft parts are formed from a magnetic material.

4. The reactor according to claim 1, wherein the number of the at least three iron cores is a multiple of three.

5. The reactor according to claim 1, wherein the number of the at least three iron cores is an even number not less than 4.
